(19) United States
(12) Patent Application Publication
(10) Pub. No.: US 2015/0249884 A1
(43) Pub. Date: Sep. 3, 2015

(54) POST-PROCESSED REFERENCE PATH FOR ACOUSTIC ECHO CANCELLATION

(71) Applicant: Google Inc., Mountain View, CA (US)

(72) Inventors: Leng Ooi, San Jose, CA (US); Jan Skoglund, San Francisco, CA (US); Andrew John MacDonald, San Francisco, CA (US)

(73) Assignee: Google Inc., Mountain View, CA (US)

(21) Appl. No.: 13/651,893

(22) Filed: Oct. 15, 2012

(51) Int. Cl. H04R 3/00

(52) U.S. Cl. CPC H04R 3/002

(57) ABSTRACT

A system includes a speaker, an acoustic echo canceller, a post-processor configured to create a post-processed render signal associated with an audio input, and a reference path operatively connected to the speaker, the post-processor, and the acoustic echo canceller. The reference path provides the acoustic echo canceller with access to the post-processed render signal.

### TECHNICAL FIELD

This description generally relates to audio and video processing, and more specifically, to acoustic echo cancellation for audio or video communication.

### BACKGROUND

An acoustic echo canceller (AEC) may help remove echoes from telephone calls or real-time web communication, such as online video chats. Echo cancellation may involve first recognizing an originally transmitted signal that re-appears, with some delay, in a transmitted or received signal. Once the echo is recognized, it can be removed by subtracting it from the transmitted or received signal. This can be implemented using an AEC, which may, for example, record a sound going to a loudspeaker and subtract it from a signal coming from a microphone.

An AEC may model an effect of an acoustic channel as a linear filter. The linear filter is applied to a signal bound for rendering, resulting in an estimate of an echo present in a captured signal. This estimate is subsequently subtracted (i.e., cancelled) from the captured signal, ideally removing the echo.

The linear filter may, however, only model linear distortions. If the channel contains non-linear distortions, the AEC may fail. In many cases, linearity is a reasonable expectation. One example of an exception, however, is in the case of post-processing on a render signal. Such post-processing could include dynamic range compression (DRC) or equalization, and is generally non-linear. That is, to make sound coming from a computing device such as a mobile phone or laptop sound better, post-processing occurs within the operating system or hardware. Yet, this processing may add distortion to the sound. When an application (such as a plugin allowing for online video communication) provides sound to the operating system or hardware layer, if the application does not know what processing is applied to the sound in those layers, the application does not know what sound is presented to an environment and it cannot appropriately cancel an echo.

The post-processing is typically applied at a driver or hardware stage, later in the signal chain than a software AEC. That is, the AEC only has access to the pre-processed render signal. If the non-linear distortion applied by the post-processing is severe enough, it can cause the AEC to fail.

Accordingly, there exists a need for systems and methods to address the shortfalls of present technology and to provide other new and innovative features.

### SUMMARY

According to one general aspect, a system may include a speaker, an acoustic echo canceller, a post-processor configured to create a post-processed render signal associated with an audio input. and a reference path operatively connected to the speaker, the post-processor, and the acoustic echo canceller. The reference path may provide the acoustic echo canceller with access to the post-processed render signal.

According to another general aspect, a method includes receiving a pre-processed render signal based on an audio input from a remote system. The method includes processing, by a post-processor, the pre-processed render signal to create a post-processed render signal. The method includes exposing, via a reference path coupled to the post-processor, the post-processed render signal to an acoustic echo canceller, and using the post-processed render signal, removing an echo via the acoustic echo canceller.

According to another general aspect, a system may include a speaker, an acoustic echo canceller, a post-processor configured to create a post-processed render signal associated with an audio input from a remote device, and a reference device operatively configured between the speaker, the post-processor, and the acoustic echo canceller. The reference device may be configured to expose the post-processed render signal to the acoustic echo canceller via a device driver.

Additional and alternative features are contemplated. For example, a central processing unit may be configured to execute an application that accesses the post-processed render signal. As another example, the acoustic echo canceller may operate at an application layer. The acoustic echo canceller may be configured to utilize the post-processed render signal to cancel an echo created by the audio input. The post-processor may be configured to create the post-processed render signal using at least one of dynamic range compression or equalization.

One or more of the implementations of the subject matter described herein can be implemented so as to realize one or more of the following advantages: removing echoes that may result from the use of real-time communication software, such as plugins, web applications, or web browser extensions.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system that provides a post-processed reference path for acoustic echo cancellation, in accordance with systems and methods described here.

FIG. 2 is a flow diagram showing an example implementation of post-processing using a reference path for acoustic echo cancellation, in accordance with systems and methods described here.

FIG. 3 is a block diagram showing example or representative computing devices and associated elements that may be used to implement systems and methods described here.

Like reference symbols in the various drawings indicate like elements.

### DETAILED DESCRIPTION

Systems and methods described here include a reference device that can feedback any audio that is being played out to an acoustic echo canceller in order to capture any distortions that happen at a hardware level or at a device driver level.

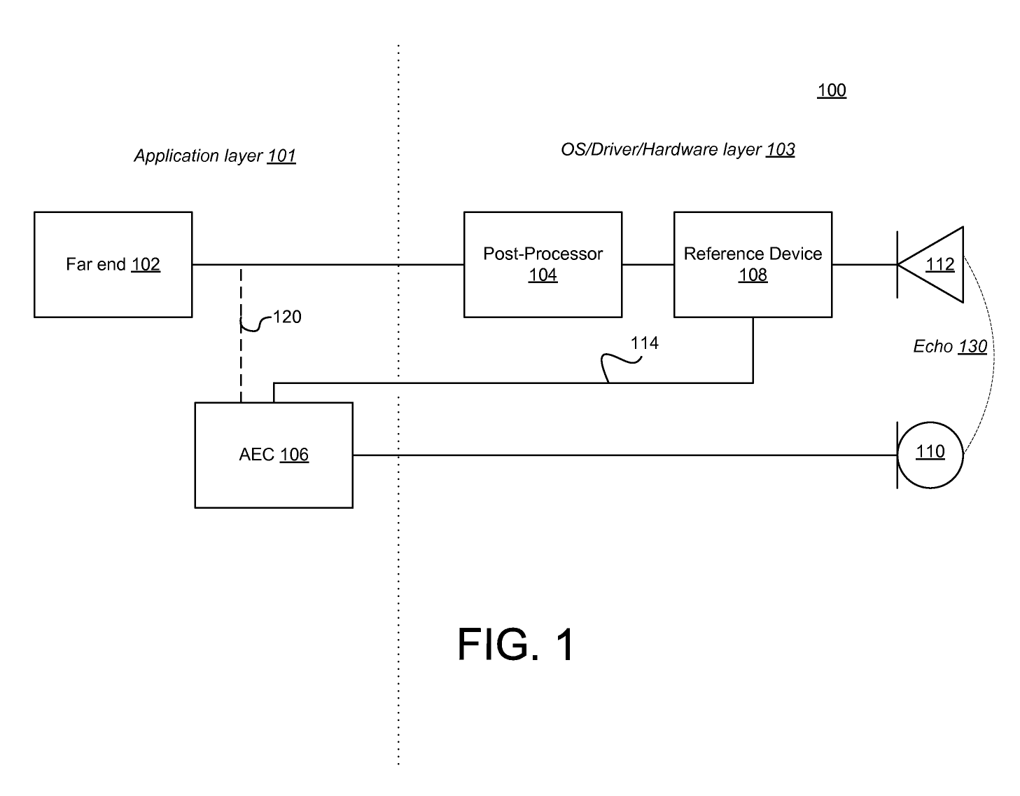

FIG. 1 is a block diagram of a system that provides a post-processed reference path for acoustic echo cancellation, in accordance with systems and methods described here.

As shown in FIG. 1, a system 100 may include an application layer 101 that includes a “far end” 102 and an AEC 106, and a operating system (OS)/Driver/Hardware layer 103 that includes a post-processor 104, a reference device 108, a microphone 110, and a speaker 112.

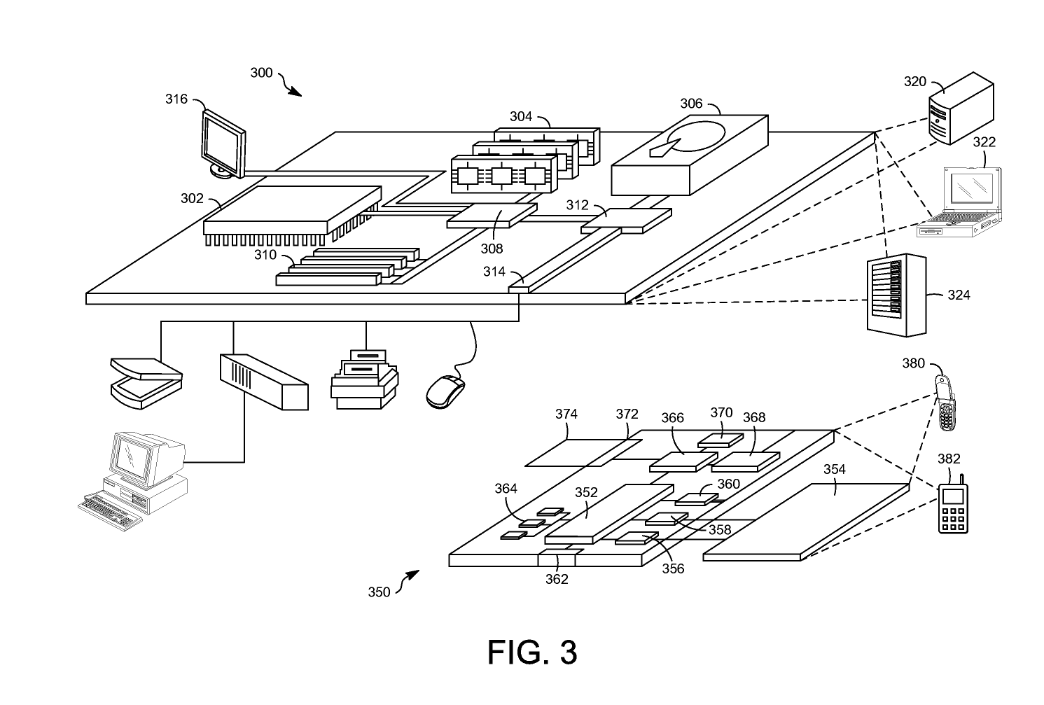

Far end 102 may represent any communication system at an application layer 101 level (as opposed to an operating system/driver/hardware layer 103) that may provide at least one signal (including, for example a signal transmitting a voice communication). For example, far end 102 may include any kind of computing device, IP phone, telephone, smart phone, mobile device, or other device, as described in more detail below with respect to FIGS. 3 and 4. Far end 102 may also include a web application, plugin, browser extension, or other software program that operates to provide real-time or near real-time audio communication (which in some implementations includes visual communication) over the Internet or other network. Such communication may occur between more than two systems, for example in the case of a virtual meeting with participants from several locations all over the world. The specific configuration of far end 102 is not critical, and while only one far end is illustrated in system 100, it may be appreciated that such illustration is merely for the sake of example, and that other implementations are possible.

The AEC 106 is an acoustic echo canceller that operates at an application layer 101 to provide echo cancellation based on audio input from far end 102. A signal provided by a system at a “far end” 102 is amplified and reinforced by loudspeakers (e.g., speaker 112) at a “near end” where the AEC 106 is located. Speaker 112 may be, for example, a computer speaker, telephone speaker, multimedia speaker, or any speaker that produces sound in response to an electrical audio signal input. The specific configuration of speaker 112 is not critical, and while only one speaker is illustrated in system 100, it may be appreciated that such illustration is merely for the sake of example, and that other implementations are possible.

The signal provided by the far end 102 and output via speaker 112 may get reflected off walls, ceiling, floors, and people at the near end, before getting picked up by a microphone 110 and transmitted back to the far end 102. For example, if a person is playing a sound through a speaker 112 instead of through a headset at the near end, the signal may be recorded by the microphone 110. This may result in an echo 130 of the sound, which is irritating to users.

In some implementations, the AEC 106 may use digital signal processing to identify audio entering the acoustic space of a “near end” e.g., a local room, via a computer, a phone line, or other connection. Before reaching the near end's loudspeakers, this audio may be used as a signal (i.e., a pre-processed render signal 120) in the AEC 106. The AEC 106 may use the pre-processed render signal 120 to subtract out signals that match the pre-processed render signal 120 from the audio signal picked up by the microphone 110. The resulting signal may then be transmitted back to the far end 102.

Microphone 110 may be any acoustic-to-electric transducer or sensor that converts sound into an electrical signal, such as a telephone microphone, laptop microphone, or other device. The specific configuration of microphone 110 is not critical, and while only one microphone is illustrated in FIG. 1, it may be appreciated that such illustration is merely for the sake of example, and that other implementations are possible.

A post-processor 104 may process an output signal after access to audio is available. Such post-processing can include dynamic range compression (DRC) or equalization, and may generally include non-linear processing. Such post-processing may be applied by, for example, the post-processor 104 at a device driver stage or at a hardware stage, later in a signal chain than the AEC 106.

Any kind of distortion due to that processing by the post-processor 104 may make it harder for the AEC 106 to remove or cancel an echo 130, at least in part because the AEC 106 may not have access to information about what kind of post-processing the post processor 104 conducted. Systems and methods described here include a reference path, described in more detail below, which can feedback any audio that is being played out (e.g., by speaker 112) to the AEC 106, in order to capture any distortions that happen at a hardware level or at a device driver level (e.g., by the post-processor 104, which may operate as hardware or at a device driver level).

The AEC 106 may utilize an algorithm at the application layer 101 to eliminate the echo 130. For example, the AEC 106 may model an effect of an acoustic channel as a linear filter (not shown). The linear filter may be applied to a signal bound for rendering, resulting in an estimate of an echo 130 present in a captured signal. This estimate is subsequently subtracted (i.e., cancelled) from the captured signal, ideally removing the echo 130.

The filter may, however, only model linear distortions. If the channel contains non-linear distortions, the AEC 106 may utilize a reference path to eliminate echoes. Accordingly, system 100 includes the “reference path” (i.e., a signal) shown in FIG. 1 as a post-processed reference signal 114. The post-processed reference signal 114 is provided from a hardware stage or device driver stage to the AEC 106, to give the AEC 106 direct access to the post-processed render signal 114. The AEC 106 may use the post-processed render signal 114, instead of, or in addition to, the pre-processed render signal 120, to remove an echo 130.

The post-processed render signal 114 may be exposed, for example, using a signal path or a hardware device (shown as a “reference device” 108 in FIG. 1) from which the AEC 106 may capture the post-processed reference signal 114 (i.e., the post-processed audio). A device driver in system 100 (not shown in FIG. 1) may expose the reference device 108 to the AEC 106, for example as another audio hardware device for which an application can record or process audio. In various implementations, the AEC 106 may access the reference signal 114 via a memory buffer in the device driver. Thus, using a reference path, reference device 108, and/or or device driver, as examples, the AEC 106 has a reference, via post-processed render signal 114, of what sound was provided through speaker 112.

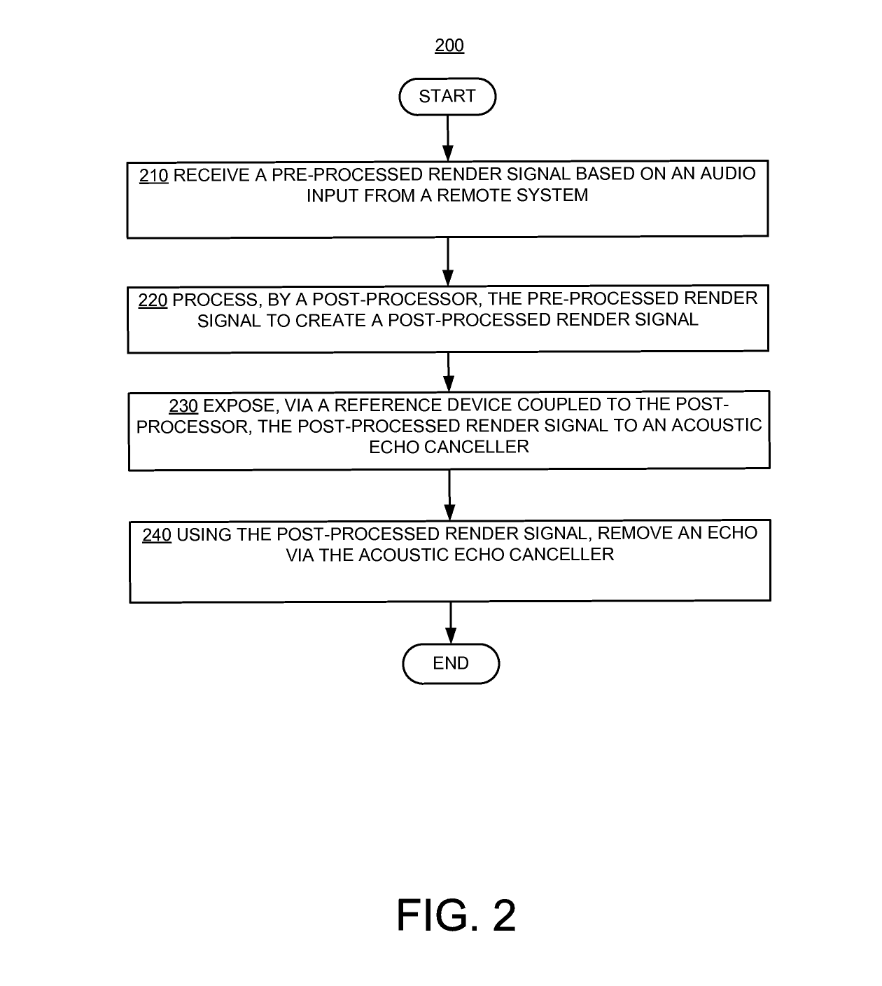

FIG. 2 is a flow diagram showing an example implementation of post-processing using a reference path for acoustic echo cancellation, in accordance with systems and methods described here. Process 200 as shown in FIG. 2 may be performed at least in part by system 100 described above with respect to FIG. 1. As shown in FIG. 2, the system may receive a pre-processed render signal based on audio input from a remote system (210). For example, the system may be a laptop computer that operates a video chat (e.g., via a web application) and gets sound from a person on another laptop device. The system may process, by a post-processor, the pre-processed render signal to create a post-processed render signal (220). The system may expose, via a reference device coupled to the post-processor, the post-processed render signal to an acoustic echo canceller (230). In some implementations, the system may expose the post-processed render signal using a reference path. Using the post-processed render signal, the system may remove an echo via the acoustic echo canceller (240). The echo may be removed by the acoustic echo canceller as described above with respect to FIG. 1, or using other implementations that account for the post-processed render signal.

FIG. 3 is a block diagram showing example or representative computing devices and associated elements that may be used to implement systems and methods described here. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, BLUETOOTH, ETHERNET, wireless ETHERNET) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can execute instructions within the computing device 350, including instructions stored in the memory 364. The processor may be implemented as a chipset of chips that include separate and multiple analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD (Thin-Film-Transistor Liquid Crystal Display) or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provide in communication with processor 352, so as to enable near area communication of device 350 with other devices. External interface 362 may provide, for example, for wired communication in some implementations, or for wireless communication in other implementations, and multiple interfaces may also be used.

The memory 364 stores information within the computing device 350. The memory 364 can be implemented as one or more of a computer-readable medium or media, a volatile memory unit or units, or a non-volatile memory unit or units. Expansion memory 374 may also be provided and connected to device 350 through expansion interface 372, which may include, for example, a SIMM (Single In Line Memory Module) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provide as a security module for device 350, and may be programmed with instructions that permit secure use of device 350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352, that may be received, for example, over transceiver 368 or external interface 362.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a BLUETOOTH, WiFi, or other such transceiver (not shown). In addition, GPS (Global Positioning System) receiver module 370 may provide additional navigation- and location-related wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smart phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system comprising:
a speaker;
an acoustic echo canceller;
a post-processor configured to create a post-processed render signal associated with an audio input; and
a reference path operatively connected to the speaker, the post-processor, and the acoustic echo canceller, wherein the reference path provides the acoustic echo canceller with access to the post-processed render signal.

2. The system of claim 1, further comprising:
a device driver configured to expose the reference path to the acoustic echo canceller.

3. The system of claim 1, further comprising:
a central processing unit configured to execute an application that accesses the post-processed render signal.

4. The system of claim 1, further comprising:
a microphone configured to receive input.

5. The system of claim 1, wherein the acoustic echo canceller accesses a pre-processed render signal at an application layer.

6. The system of claim 1, wherein the speaker is one of a laptop computer speaker, a telephone speaker, or a smartphone speaker.

7. The system of claim 1, wherein the acoustic echo canceller is configured to utilize the post-processed render signal to cancel an echo created by the audio input.

8. The system of claim 1, wherein the post-processor is a hardware device.

9. A method comprising:
receiving a pre-processed render signal based on an audio input from a remote system;
processing, by a post-processor, the pre-processed render signal to create a post-processed render signal;
exposing, via a reference path coupled to the post-processor, the post-processed render signal to an acoustic echo canceller; and
using the post-processed render signal, removing an echo via the acoustic echo canceller.

10. The method of claim 9, further comprising:
comparing, by the acoustic echo canceller, a microphone input to the post-processed render signal.

11. The method of claim 9, further comprising:
after removing the echo, providing a result signal via the acoustic echo canceller to the remote system.

12. The method of claim 9, further comprising:
comparing, by the acoustic echo canceller, the pre-processed render signal to the post-processed render signal.

13. The method of claim 12, further comprising:
creating, by the acoustic echo canceller, a result signal without the echo based on the comparing.

14. A system comprising:
a speaker;
an acoustic echo canceller;
a post-processor configured to create a post-processed render signal associated with an audio input from a remote device; and
a reference device operatively configured between the speaker, the post-processor, and the acoustic echo canceller, the reference device configured to expose the post-processed render signal to the acoustic echo canceller via a device driver.

15. The system of claim 14, further comprising:
a central processing unit configured to execute an application that accesses the post-processed render signal.

16. The system of claim 14, further comprising:
a microphone configured to receive input.

17. The system of claim 14, wherein the acoustic echo canceller operates at an application layer.

18. The system of claim 14, wherein the speaker is one of a laptop computer speaker, a telephone speaker, or a smartphone speaker.

19. The system of claim 14, wherein the acoustic echo canceller is configured to utilize the post-processed render signal to cancel an echo created by the audio input.

20. The system of claim 14, wherein the post-processor is configured to create the post-processed render signal using at least one of dynamic range compression or equalization.
